(19) United States
(12) Patent Application Publication
(10) Pub. No.: US 2026/0171730 A1
(43) Pub. Date: Jun. 18, 2026

(54) ELECTRICAL CONNECTION ASSEMBLY AND CHARGING DEVICE

(71) Applicants: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(72) Inventors: Fangyue (Jason) Zhu, Shanghai (CN); Haifei (Felix) Yu, Suzhou (CN); Jinshun (Jet) Wang, Suzhou (CN)

(73) Assignees: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(21) Appl. No.: 19/417,705

(22) Filed: Dec. 12, 2025

(30) Foreign Application Priority Data
Dec. 13, 2024 (CN) 202423095149.0

(51) Int. Cl. H01R 13/66; B60L 53/16; H01R 4/02; H01R 4/72; H01R 13/52; H01R 13/627

(52) U.S. Cl. CPC H01R 13/6683; B60L 53/16; H01R 4/021; H01R 4/72; H01R 13/5202; H01R 13/5205; H01R 13/5213; H01R 13/6273; H01R 2201/26

(57) ABSTRACT

An electrical connection assembly includes an installation cylinder, a cable, a terminal, a temperature sensor, and a heat shrink tube. The installation cylinder has a front end and a rear end opposite each other in an axial direction of the installation cylinder. The cable passes through the installation cylinder and has a conductor end extending from the front end of the installation cylinder. The terminal has a connection end electrically connected to the conductor end. The temperature sensor is in thermal contact with the connection end and has leads passing through the installation cylinder. The heat shrink tube is fitted and heat shrunk onto the rear end of the installation cylinder, the cable, and the leads led out from the rear end of the installation cylinder. The heat shrink tube achieves sealing between the cable, the leads, and the installation cylinder. The temperature sensor detects a temperature of the terminal.

### CROSS-REFERENCE TO RELATED APPLICATION

This application claims the benefit of the filing date under 35 U.S.C. § 119(a)-(d) of Chinese Patent Application No. CN202423095149.0 filed on Dec. 13, 2024, the whole disclosure of which is incorporated herein by reference.

### FIELD OF THE INVENTION

The present invention relates to an electrical connection assembly and, more particularly, to an electrical connection assembly and a charging device comprising the electrical connection assembly.

### BACKGROUND OF THE INVENTION

A DC charging dock typically includes a housing, a charging terminal, a cable, and a temperature sensor. The charging terminal is set in the housing. The temperature sensor is installed in the housing and fixed to the charging terminal to detect the temperature of the charging terminal. One end of the cable extends into the housing and is welded to the charging terminal. The cable and the leads of the temperature sensor are led out from the rear port of the housing. In order to achieve sealing between the cable and the leads of the temperature sensor and the housing, an elastic seal needs to be installed in the rear port of the housing. The cable and the leads of the temperature sensor pass through the elastic seal, which is radially compressed in the rear port of the housing to achieve sealing between the cable and the leads of the temperature sensor and the housing. However, the typical DC charging dock has a complex structure and a low assembly efficiency.

### SUMMARY OF THE INVENTION

An electrical connection assembly includes an installation cylinder, a cable, a terminal, a temperature sensor, and a heat shrink tube. The installation cylinder has a front end and a rear end opposite each other in an axial direction of the installation cylinder. The cable passes through the installation cylinder and has a conductor end extending from the front end of the installation cylinder. The terminal has a connection end electrically connected to the conductor end. The temperature sensor is in thermal contact with the connection end and has leads passing through the installation cylinder. The heat shrink tube is fitted and heat shrunk onto the rear end of the installation cylinder, the cable, and the leads led out from the rear end of the installation cylinder. The heat shrink tube achieves sealing between the cable, the leads, and the installation cylinder. The temperature sensor detects a temperature of the terminal.

### BRIEF DESCRIPTION OF DRAWINGS

The invention will now be described by way of example with reference to the accompanying figures, of which:

FIG. 1 is a perspective view of a charging device according to an exemplary embodiment;

FIG. 2 is a partial exploded view of the charging device of FIG. 1;

FIG. 3 is a perspective view of an electrical connection assembly according to an exemplary embodiment;

FIG. 4 is a partial exploded view of the electrical connection assembly of FIG. 3;

FIG. 5 is another partial exploded view of the electrical connection assembly of FIG. 3;

FIG. 6 is a perspective view of an installation cylinder of the electrical connection assembly of FIG. 3;

FIG. 7 is a perspective view of a temperature sensor passing through the installation cylinder of FIG. 6;

FIG. 8 is an axial sectional view of the electrical connection assembly of FIG. 1, where a heat shrink tube has not yet been heat shrunk onto a cable and leads; and

FIG. 9 is an axial sectional view of the electrical connection assembly of FIG. 1, where the heat shrink tube of FIG. 8 has been heat shrunk onto the cable of FIG. 8 and the leads of FIG. 8.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are not schematically shown in order to simplify the drawing.

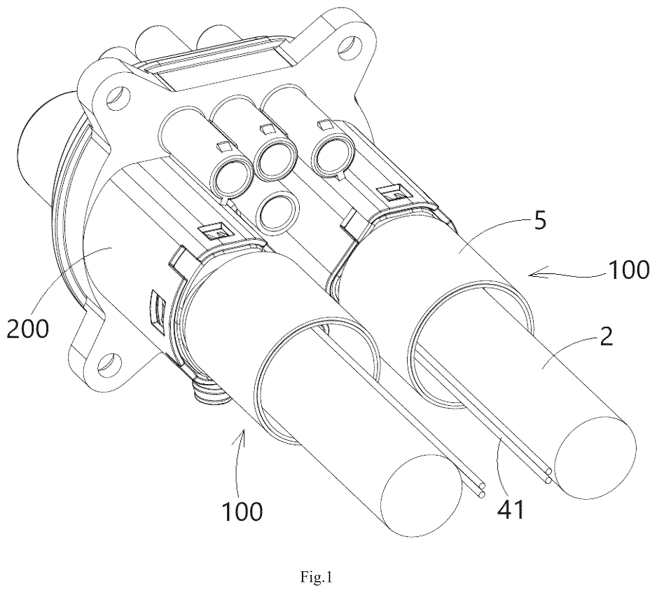

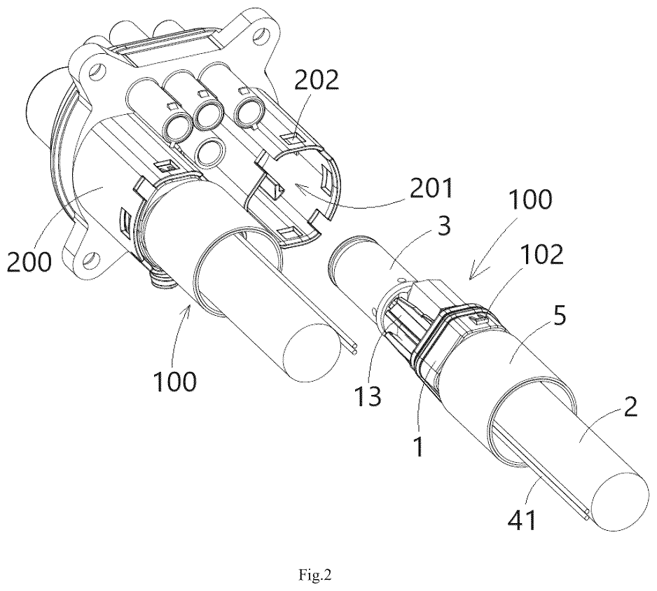

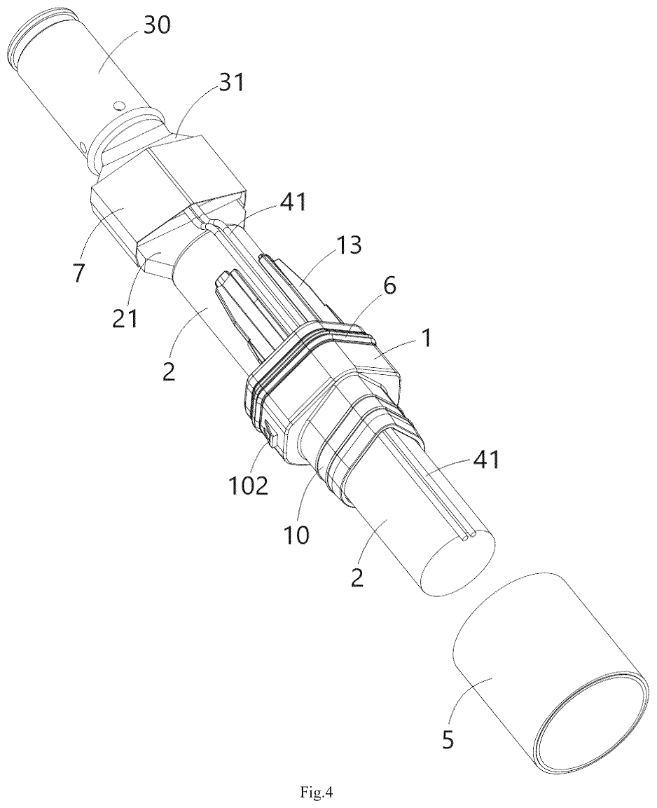

An exemplary embodiment of an electrical connection assembly 100 will now be described with reference to FIGS. 1-9. As shown in FIGS. 2-3 and 5 the electrical connection assembly 100 includes an installation cylinder 1, a cable 2, a terminal 3, a temperature sensor 4, and a heat shrink tube 5. The installation cylinder 1 has front and rear ends 10, as shown in FIGS. 4, 6, and 8-9, that are opposite in its axial direction. The cable 2 passes through the installation cylinder 1 and has a conductor end 21, as shown in FIGS. 4-5 and 8, extending from the front end of installation cylinder 1. The terminal 3 includes a connection end 31, as shown in FIGS. 4-5 and 8, that is electrically connected to the conductor end 21 of cable 2. The temperature sensor 4 is in thermal contact with the connection end 31 of terminal 3, and its leads 41, as shown in FIGS. 1, 4-5, and 8-9, pass through the installation cylinder 1. The heat shrink tube 5 is fitted and heat shrunk onto the rear end 10 of the installation cylinder 1, as well as onto the cable 2 and leads 41 that are led out from the rear end 10 of the installation cylinder 1. The temperature sensor 4 is used to detect the temperature of terminal 3, and the heat shrink tube 5 is used to achieve sealing between the cable 2, the leads 41 and the installation cylinder 1.

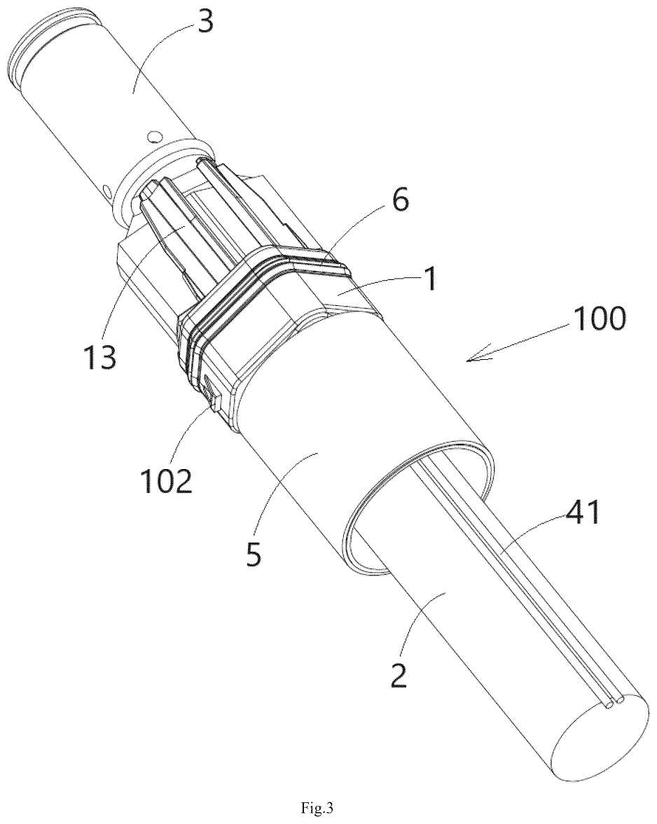

As shown in FIGS. 3-4, 6, and 8, the electrical connection assembly 100 further comprises a sealing ring 6. The sealing ring 6 is fitted onto the front end of the installation cylinder 1. The electrical connection assembly 100 is suitable for insertion into a mounting hole 201, as shown in FIG. 2, in a housing 200 of a charging device, and the sealing ring 6 is suitable for being radially compressed between the installation cylinder 1 and the inner peripheral wall of the mounting hole 201 of the housing 200 to achieve sealing between the two.

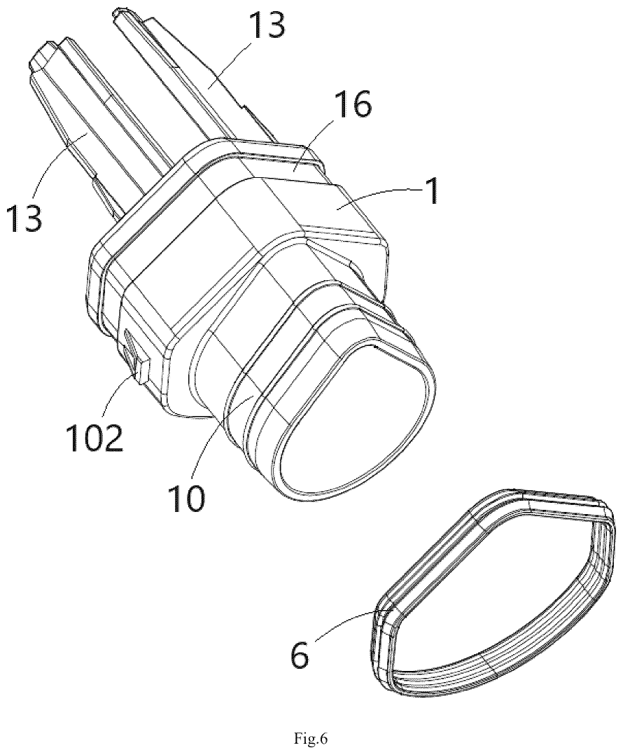

As shown in FIG. 6, a sealing ring installation groove 16 is formed on the outer peripheral surface of the front end of the installation cylinder 1. The sealing ring 6 is installed in the sealing ring installation groove 16.

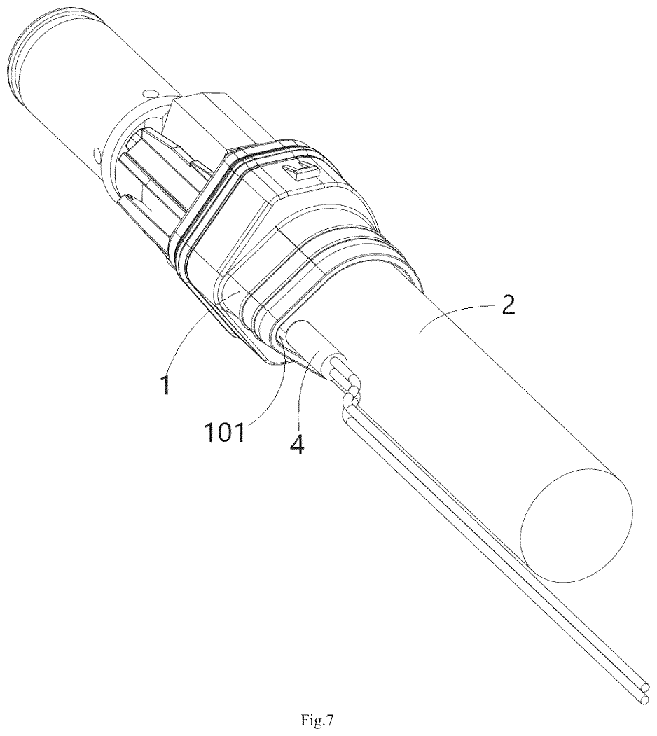

The cross-section of the installation cylinder 1 is non-circular, so that there is a gap 101, as shown in FIG. 7, between the installation cylinder 1 and the cable 2 passing through the installation cylinder 1 that allows the temperature sensor 4 to pass through. The cable 2 passes through the installation cylinder 1 from rear to front, and the temperature sensor 4 passes through the installation cylinder 1 from rear to front through the gap 101 after the cable 2 passes through the installation cylinder 1. In this way, it facilitates the assembly operation of electrical connection assembly 100 and can improve assembly efficiency.

The heat shrink tube 5 is pre-installed on the rear end 10 of the installation cylinder 1 before the cable 2 passes through the installation cylinder 1. As shown in FIG. 9, after the cable 2 and the temperature sensor 4 pass through the installation cylinder 1, the heat shrink tube 5 is heat shrunk onto the installation cylinder 1, the cable 2, and the leads 41. In this way, it facilitates the assembly operation of electrical connection assembly 100 and can improve assembly efficiency.

As shown in FIGS. 4-5 and 8, the electrical connection assembly 100 further comprises a heat shrink sleeve 7. The heat shrink sleeve 7 is fitted and heat shrunk on the connection end 31 of the terminal 3, the main body 40 of the temperature sensor 4, and the conductor end 21 of the cable 2, to fix the main body 40 of the temperature sensor 4 to the connection end 31 of the terminal 3.

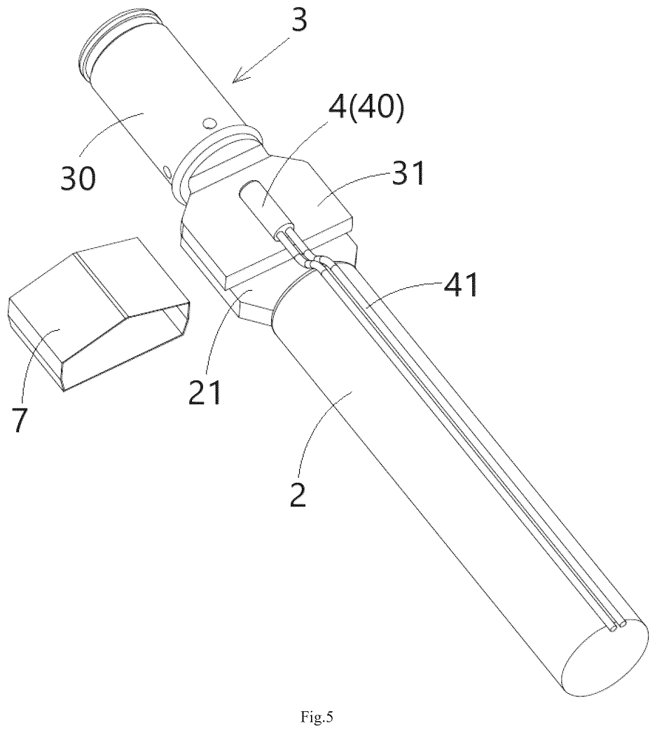

As shown in FIG. 5, the connection end 31 of the terminal 3 is flat, with first and second surfaces opposite in its thickness direction. The conductor end 21 of the cable 2 is electrically connected to the first surface of the connection end 31 of the terminal 3, and the main body 40 of the temperature sensor 4 is in thermal contact with the second surface of the connection end 31 of the terminal 3. As shown in FIG. 5, the conductor end 21 of the cable 2 is flat and welded to the first surface of the connection end 31 of the terminal 3.

As shown in FIGS. 2-4 and 6, multiple protrusions 102 are formed on the outer peripheral surface of the installation cylinder 1. The multiple protrusions 102 are located behind the sealing ring 6 and distributed at intervals in the circumferential direction of the installation cylinder 1. The multiple protrusions 102 are used to engage with multiple slots 202, as shown in FIG. 2, on the peripheral wall of the mounting hole 201 of the housing 200, respectively, to fix the installation cylinder 1 into the mounting hole 201 of the housing 200.

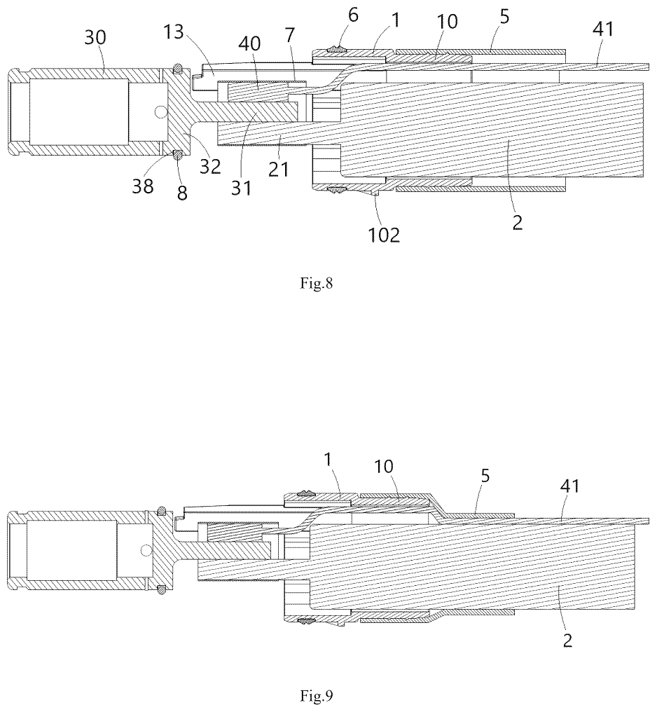

As shown in FIGS. 4-5, the terminal 3 further comprises a cylindrical body 30. The cylindrical body 30 has a front port and a rear end wall 32, as shown in FIG. 8, opposite in its axial direction. The cylindrical body 30 of the terminal 3 is used to mate with a mating terminal inserted from its front port. The connection end 31 of the terminal 3 is connected to the rear end wall 32 of the cylindrical body 30 and extends backwards from the rear end wall 32 of the cylindrical body 30.

As shown in FIG. 8, the electrical connection assembly 100 further comprises a circular seal 8. The circular seal 8 is fitted onto the rear end of the cylindrical body 30 of the terminal 3. The circular seal 8 is suitable for being radially compressed between the cylindrical body 30 of the terminal 3 and the inner peripheral wall of the mounting hole 201 of the housing 200 to achieve sealing between the two.

As shown in FIG. 8, a circular seal installation groove 38 is formed on the outer peripheral surface of the rear end of the cylindrical body 30 of the terminal 3. The circular seal 8 is installed in the circular seal installation groove 38.

The electrical connection assembly 100 is suitable for insertion into the mounting hole 201 of the housing 200 of the charging device. As shown in FIGS. 2-4, 6, and 8, the installation cylinder 1 has a locking portion 13 extending forward from its front end. The locking portion 13 is adapted to press against the terminal 3 along the axial direction of the mounting hole 201 to lock the terminal 3 in the mounting hole 201. In the illustrated embodiment, the locking portion 13 is cantilevered. The locking portion 13 of the installation cylinder 1 is adapted to axially rest against the rear end face of the cylindrical body 30 of the terminal 3.

An exemplary embodiment of a charging device will now be described with reference to FIGS. 1-9. As shown in FIG. 1-2, the charging device includes the housing 200 and the electrical connection assembly 100. The housing 200 is formed with the mounting hole 201, as shown in FIG. 2. The electrical connection assembly 100 is inserted into the mounting hole 201 of the housing 200. The cable 2 and the leads 41 of the temperature sensor 4 are led out from the mounting hole 201. Multiple mounting holes 201 are formed in the housing 200, and the charging device includes multiple electrical connection assemblies 100, which are respectively inserted into the multiple mounting holes 201 of the housing 200.

As shown in FIG. 2, there are multiple slots 202 on the peripheral wall of the mounting hole 201 of the housing 200, which are distributed at intervals in the circumferential direction of the mounting hole 201. The multiple slots 202 are used to engage with the multiple protrusions 102 on the installation cylinder 1, respectively, to lock the installation cylinder 1 into the mounting hole 201 of the housing 200.

In the illustrated embodiment, the charging device is a charging dock. However, the present invention is not limited to the illustrated embodiments, for example, the charging device may be a charging gun.

In the aforementioned exemplary embodiments according to the present invention, the modular electrical connection assembly 100 can be conveniently inserted into the mounting holes 201 of the housing 200, simplifying the assembly process of the charging device and improving the assembly efficiency of the charging device. In addition, in the present invention, the heat shrink tube 5 is used to achieve sealing between the cable 2 and the leads 41 of temperature sensor 4 and the installation cylinder 1, simplifying the sealing structure of the electrical connection assembly 100.

It should be appreciated by those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. An electrical connection assembly, comprising:
an installation cylinder having a front end and a rear end opposite each other in an axial direction of the installation cylinder;
a cable passing through the installation cylinder and having a conductor end extending from the front end of the installation cylinder;
a terminal having a connection end electrically connected to the conductor end;
a temperature sensor in thermal contact with the connection end and having leads passing through the installation cylinder; and
a heat shrink tube fitted and heat shrunk onto the rear end of the installation cylinder, the cable, and the leads led out from the rear end of the installation cylinder, the heat shrink tube achieves sealing between the cable, the leads, and the installation cylinder, the temperature sensor detects a temperature of the terminal.

2. The electrical connection assembly of claim 1, further comprising a sealing ring fitted onto the front end of the installation cylinder, the electrical connection assembly is inserted into a mounting hole in a housing of a charging device, and the sealing ring is radially compressed between the installation cylinder and an inner peripheral wall of the mounting hole of the housing to achieve sealing between the two.

3. The electrical connection assembly of claim 2, wherein a sealing ring installation groove is formed on an outer peripheral surface of the front end of the installation cylinder, the sealing ring is installed in the sealing ring installation groove.

4. The electrical connection assembly of claim 1, wherein a cross-section of the installation cylinder is non-circular, such that there is a gap between the installation cylinder and the cable passing through the installation cylinder, the cable passes through the installation cylinder from rear to front, and the temperature sensor passes through the gap from rear to front after the cable passes through the installation cylinder.

5. The electrical connection assembly of claim 4, wherein the heat shrink tube is pre-installed on the rear end of the installation cylinder before the cable passes through the installation cylinder, the heat shrink tube is heat shrunk onto the installation cylinder, the cable, and the leads after the cable and the temperature sensor pass through the installation cylinder.

6. The electrical connection assembly of claim 1, further comprising a heat shrink sleeve fitted and heat shrunk onto the connection end, a main body of the temperature sensor, and the conductor end to fix the main body of the temperature sensor to the connection end.

7. The electrical connection assembly of claim 6, wherein the connection end is flat, the connection end has a first surface and a second surface opposite each other in a thickness direction, the conductor end is electrically connected to the first surface of the connection end, and the main body of the temperature sensor is in thermal contact with the second surface of the connection end.

8. The electrical connection assembly of claim 7, wherein the conductor end is flat and welded to the first surface of the connection end.

9. The electrical connection assembly of claim 2, wherein a plurality of protrusions are formed on an outer circumferential surface of the installation cylinder, the plurality of protrusions are behind the sealing ring and distributed at intervals in a circumferential direction of the installation cylinder, the plurality of protrusions respectively engage with a plurality of slots on a peripheral wall of the mounting hole to fix the installation cylinder into the mounting hole.

10. The electrical connection assembly of claim 9, wherein the terminal has a cylindrical body, the cylindrical body has a front port and a rear end wall opposite in an axial direction of the cylindrical body, the cylindrical body mates with a mating terminal inserted in the front port, the connection end is connected to the rear end wall of the cylindrical body and extends backwards from the rear end wall of the cylindrical body.

11. The electrical connection assembly of claim 10, further comprising a circular seal fitted onto a rear end of the cylindrical body, the circular seal is radially compressed between the cylindrical body and the inner peripheral wall of the mounting hole of the housing to achieve sealing between the two.

12. The electrical connection assembly of claim 11, wherein a circular seal installation groove is formed on an outer peripheral surface of the rear end of the cylindrical body, the circular seal is installed in the circular seal installation groove.

13. The electrical connection assembly of claim 1, wherein the electrical connection assembly is inserted into a mounting hole of a housing of a charging device, the installation cylinder has a locking portion extending forward from the front end of the installation cylinder.

14. The electrical connection assembly of claim 13, wherein the locking portion rests on the terminal along an axial direction of the mounting hole to lock the terminal in the mounting hole.

15. The electrical connection assembly of claim 14, wherein the locking portion axially rests against a rear end face of a cylindrical body of the terminal.

16. A charging device, comprising:
a housing formed with a mounting hole; and
an electrical connection assembly, including:
an installation cylinder having a front end and a rear end opposite each other in an axial direction of the installation cylinder;
a cable passing through the installation cylinder and having a conductor end extending from the front end of the installation cylinder;
a terminal having a connection end electrically connected to the conductor end;
a temperature sensor in thermal contact with the connection end and having leads passing through the installation cylinder; and
a heat shrink tube fitted and heat shrunk onto the rear end of the installation cylinder, the cable, and the leads led out from the rear end of the installation cylinder, the heat shrink tube achieves sealing between the cable, the leads, and the installation cylinder, the temperature sensor detects a temperature of the terminal, the electrical connection assembly is inserted into the mounting hole, the cable and the leads are led out from the mounting hole.

17. The charging device of claim 16, wherein a plurality of mounting holes are formed in the housing, and the charging device has a plurality of electrical connection assemblies, the electrical connection assemblies are respectively inserted into the mounting holes.

18. The charging device of claim 16, wherein a plurality of slots are formed on a peripheral wall of the mounting hole, the slots are distributed at intervals in a circumferential direction of the mounting hole, the slots respectively engage with a plurality of protrusions on the installation cylinder to lock the installation cylinder into the mounting hole.

19. The charging device of claim 16, wherein the charging device is a charging dock or a charging gun.
